(19) United States
(12) Patent Application Publication
(10) Pub. No.: US 2025/0329793 A1
(43) Pub. Date: Oct. 23, 2025

(54) SECONDARY BATTERY AND METHOD OF MANUFACTURING SAME

(71) Applicant: Samsung SDI Co., Ltd., Yongin-si (KR)

(72) Inventor: Taewoong Jang, Yongin-si (KR)

(73) Assignee: Samsung SDI Co., Ltd., Yongin-si (KR)

(21) Appl. No.: 18/922,056

(22) Filed: Oct. 21, 2024

(30) Foreign Application Priority Data
Apr. 23, 2024 (KR) 10-2024-0054241

(51) Int. Cl. H01M 10/0587; H01M 10/04; H01M 50/109; H01M 50/153; H01M 50/469; H01M 50/538; H01M 50/566

(52) U.S. Cl. CPC H01M 10/0587; H01M 10/0431; H01M 50/109; H01M 50/153; H01M 50/469; H01M 50/538; H01M 50/566

(57) ABSTRACT

A secondary battery, including, in some examples: an electrode assembly comprising a positive electrode plate and a negative electrode plate separated by a separator and wound in a cylindrical shape, a positive electrode tab spaced apart from an outer circumferential surface of the cylindrical shape toward an inside of the cylindrical shape and connected to the positive electrode plate, and a negative electrode tab connected to the negative electrode plate; a housing can configured to receive the electrode assembly, electrically connected to the negative electrode tab, and having an open area at one side; and a cap assembly electrically connected to the positive electrode tab and configured to close the open area to seal the electrode assembly from an outside region.

### CROSS-REFERENCE TO RELATED APPLICATIONS

This present application claims priority to and the benefit under 35 U.S.C. § 119 (a)-(d) of Korean Patent Application No. 10-2024-0054241, filed on Apr. 23, 2024, in the Korean Intellectual Property Office, the entire disclosure of which is incorporated herein by reference.

### FIELD

The present disclosure relates to a secondary battery and a method of manufacturing the same and to a secondary battery having a height smaller than a width and a method of manufacturing the same.

### BACKGROUND

In recent years, the growing demand for wearable devices such as Bluetooth-enabled headphones, earphones, smart watches, and body-worn medical devices has increased the demand for ultra-small secondary batteries having a high energy density and a sufficiently small size.

Ultra-small secondary batteries are secondary batteries that may be significantly smaller in height than width, depending on the nature of applications, and may include coin batteries and button batteries.

The above information disclosed in this Background section is for enhancement of understanding of the background of the present disclosure, and therefore, it may contain information that does not constitute related (or prior) art.

### SUMMARY

The embodiments of the present disclosure may improve upon problems described herein. An objective of the present disclosure is to provide an ultra-small secondary battery in which a bend of a positive electrode tab is disposed to be spaced apart from an outer circumferential surface of an electrode assembly.

Another objective of the present disclosure is to provide a method of manufacturing the ultra-small secondary battery described above.

These and other aspects and features of the present disclosure will be described in or will be apparent from the following description of embodiments of the present disclosure.

According to one or more embodiments of the present disclosure, a secondary battery includes: an electrode assembly including a positive electrode plate and a negative electrode plate separated by a separator and wound in a cylindrical shape, a positive electrode tab spaced apart from an outer circumferential surface of the cylindrical shape toward an inside of the cylindrical shape and connected to the positive electrode plate, and a negative electrode tab connected to the negative electrode plate; a housing can configured to receive the electrode assembly, the housing can electrically connected to the negative electrode tab and having an open area at one side; and a cap assembly electrically connected to the positive electrode tab and configured to close the open area to seal the electrode assembly from outside (an outside region).

In some embodiments, the positive electrode plate may include a strap-shaped positive electrode substrate comprising a positive electrode coated portion to which a positive electrode active material may be applied and a positive electrode uncoated portion to which the positive electrode active material may not be applied, and the positive electrode tab may be positioned on the positive electrode uncoated portion to be spaced apart from a positive electrode edge, which may be an end of the positive electrode substrate, by a spacing area corresponding to a spacing distance.

In some embodiments, the positive electrode edge may be provided as the outer circumferential surface after winding (being wound in the cylindrical shape), and the spacing distance may range from 3 millimeters (mm) to 10 mm.

In some embodiments, the positive electrode plate may further include an additional positive electrode coated portion in which a portion of the positive electrode substrate corresponding to the spacing area may be coated with the positive electrode active material.

In some embodiments, the positive electrode tab may include a first vertical extension configured to extend from the positive electrode uncoated portion in a height direction of the electrode assembly; a first horizontal joint configured to extend horizontally along a top surface of the electrode assembly; and a first bend configured to connect the first vertical extension and the first horizontal joint.

In some embodiments, the positive electrode tab may further include a first cover tape covering a portion of the first vertical extension, the first bend, and the first horizontal joint to be fixed to the electrode assembly.

In some embodiments, the first bend may be configured to have a width smaller than either the first vertical extension or the first horizontal joint, such that an area of the first cover tape corresponding to the first bend has a width smaller than an area corresponding to either the first vertical extension or the first horizontal joint.

In some embodiments, the cap assembly may include a disk-shaped insulating washer configured to have a first open area in a central portion to expose a winding shaft and configured to cover the positive electrode tab; a cap plate disposed on a top surface of the insulating washer and having a second open area having a same center as the first open area, with an edge thereof joined to the housing can; a terminal insulating layer disposed on the cap plate and having a third open area having the same center as the first open area and the second open area; and a positive electrode terminal configured to include a terminal plate configured to seal the electrode assembly by covering the terminal insulating layer and a joining protrusion extending downward from the terminal plate and through the first to the third open areas to be joined to the positive electrode tab.

In some embodiments, a top portion of the housing can may include a joining step surface, and the edge of the cap plate may be welded to the joining step surface.

In some embodiments, the first bend may be positioned in an area where radiant heat from welding of the joining step surface and the cap plate may be less than 50% of welding heat, thereby preventing or reducing the melting of the first cover tape by the welding.

In some embodiments, the first bend may have a spacing ranging from 4 mm to 11 mm from a sidewall of the housing can on a bottom of the joining step surface.

In some embodiments, an outer edge of the insulating washer may be disposed closer to the housing can than the first bend so as to be positioned between a sidewall of the housing can and the first bend.

In some embodiments, a height to diameter ratio of the housing can May be less than 1.

In some embodiments, the positive electrode plates, the separators, and the negative electrode plates are wound around a winding axis disposed perpendicularly to a bottom of the housing can, and the positive electrode plates and the negative electrode plates are disposed alternately from the winding axis toward the outer circumferential surface.

In some embodiments, the embodiments may be realized by providing a method of manufacturing a secondary battery, the method including forming an electrode assembly comprising a positive electrode plate and a negative electrode plate separated by a separator and wound in a cylindrical shape, a positive electrode tab spaced apart from an outer circumferential surface of the cylindrical shape to an inside of the cylindrical shape and connected to the positive electrode plate, and a negative electrode tab connected to the negative electrode plate; inserting the electrode assembly in a housing can such that the negative electrode tab may be electrically connected thereto to form a housing structure in which the positive electrode tab protrudes upward from the electrode assembly; joining the positive electrode tab protruding from the electrode assembly to a cap assembly; and joining the cap assembly with the positive electrode tab joined thereto to the housing can.

In some embodiments, the positive electrode tab may be formed at a position spaced apart from an end of the positive electrode plate by a distance ranging from 3 mm to 10 mm, and the negative electrode tab may be formed on an end of the negative electrode plate.

In some embodiments, the operation of joining the positive electrode tab to the cap assembly may include fixing the housing structure to an alignment substrate; aligning a cap fixing terminal to which the cap assembly may be fixed with the positive electrode tab; and joining a positive electrode terminal provided on the cap assembly to the positive electrode tab.

In some embodiments, the joining of the positive electrode terminal and the positive electrode tab may be performed by laser welding.

In some embodiments, the joining of the cap assembly and the housing can may include pressing the cap assembly joined to the positive electrode tab to be aligned with a top portion of the housing can; and laser-welding the cap assembly along peripheral portions of the housing can.

In some embodiments, in the aligning of the cap assembly to the top portion of the housing can, an entire top surface of the cap assembly may be pressed against the housing can using an alignment roller to fit an edge of a cap plate provided on the cap assembly to a joining step surface provided on an end of the housing can.

According to the above-described ultra-small secondary battery and the method of manufacturing the same, disposing the positive electrode tab within the jelly roll by moving the position of the positive electrode tab from the outer surface of the electrode assembly toward the winding shaft may prevent the first cover tape from dissolving and the positive electrode tab from being exposed during welding of the housing can and the cap plate.

Accordingly, in some embodiments, short-circuit defects in which the cap plate and the positive electrode tab are in contact may be prevented. In particular, even in a case where the size of the housing can is reduced, a situation in which the first cover tape dissolves due to welding or the positive electrode tab and the cap plate contact each other may be effectively prevented, thereby increasing the operational stability of the ultra-small secondary battery.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates a perspective view showing an ultra-small secondary battery according to some embodiments of the present disclosure;

FIG. 2 illustrates an exploded perspective view showing the ultra-small secondary battery shown in FIG. 1;

FIG. 3 illustrates a cross-sectional view showing the ultra-small secondary battery shown in FIG. 1, taken in direction I-I′;

FIG. 4 illustrates a plan view of the positive electrode plate (shown in FIG. 3) before rolling (spread shape);

FIG. 5 illustrates an exemplary, modified embodiment of the positive electrode shown in FIG. 4 according to some embodiments;

FIG. 6 illustrates a spread shape of the negative electrode plate shown in FIG. 3;

FIG. 7 illustrates a perspective view schematically showing the electrode assembly shown in FIG. 2;

FIG. 8 illustrates a perspective view schematically showing the cap assembly shown in FIG. 3;

FIG. 9 illustrates a modified positive electrode tab according to some embodiments of the present disclosure; and

FIG. 10 illustrates a flowchart showing a method of manufacturing the ultra-small secondary battery shown in FIG. 1 according to some embodiments.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and including concepts consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (or under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

A typical ultra-small battery can include a housing can to receive an electrode assembly having a jelly roll structure and a cap assembly bonded to the upper portion of the housing can to seal the electrode assembly from the outside. A positive electrode tab extending upward from the electrode assembly can be configured to be connected to an electrode terminal provided on the cap assembly, and a negative electrode tab extending downward can be configured to be connected to the housing can. The positive electrode tab can extend from a positive electrode uncoated portion of the electrode assembly to an electrode terminal bent from the top surface of the electrode assembly and disposed on the central portion of the cap assembly, and the positive electrode tab may be firmly fixed to the electrode assembly with a cover tape.

In particular, because the positive electrode tab may extend from the outermost edge of the cylindrical electrode assembly toward the center, the cover tape also may extend from the outermost edge toward the center of the electrode assembly, thereby fixing the positive electrode tab to the electrode assembly.

However, in a case where the positive electrode tab and the cover tape having a square shape extend from the outer circumference to the center of the cylindrical electrode assembly, the cover tape covering the positive electrode tab may melt due to the interference between a welding path and the positive electrode tab at a position adjacent to the vertex of the square shape, thereby resulting in a welding defect or a short-circuit defect, e.g., a contact with the cap plate provided as a negative electrode on the upper portion of the positive electrode tab.

In particular, in a case where the size of the housing can is reduced while the width of the positive electrode tabs remains the same, the possibility of welding interference of the positive electrode tabs near the apex (vertex) due to the difference in shape may be further increased, thereby resulting in the possibility of a welding defect or a short-circuit defect.

As a result, there is a growing demand for a novel ultra-compact secondary battery having a structure capable of reducing welding defects and short-circuit defects caused by welding interference of the positive electrode tab.

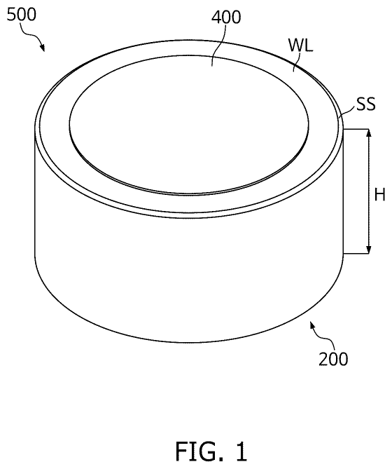

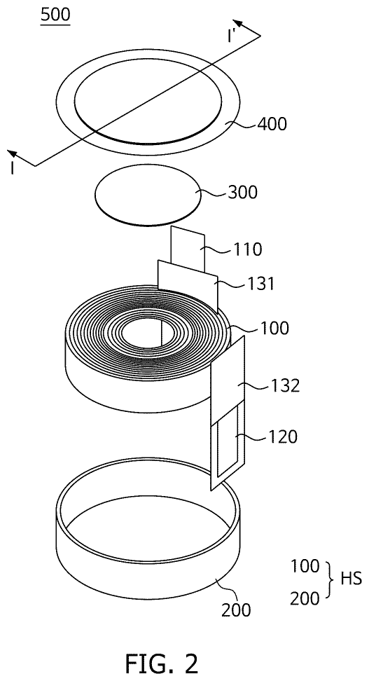

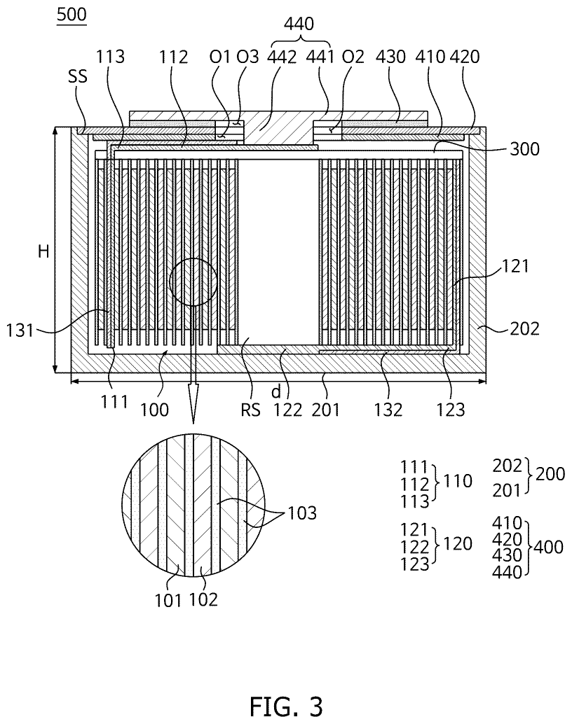

FIG. 1 illustrates a perspective view showing an ultra-small secondary battery according to embodiments of the present disclosure. FIG. 2 illustrates an exploded perspective view showing the ultra-small secondary battery shown in FIG. 1. FIG. 3 illustrates a cross-sectional view showing the ultra-small secondary battery shown in FIG. 1, taken in direction I-I′.

A secondary battery according to one or more embodiments is a micro-sized secondary battery and may be a coin cell or a button cell but is not limited thereto and may be a cylindrical or pin-type battery.

The coin cell or button cell is a battery in the form of a thin coin or button and may refer to a battery having a ratio of height to diameter (height/diameter) of 1 or less but is not limited thereto. Because the coin cell or button cell is generally cylindrical, the cross section in the horizontal direction is generally circular. However, the cross section in the horizontal direction is not limited thereto and may have an elliptical or polygonal shape. The diameter may refer to a maximum distance in the horizontal direction of the battery, and the height may refer to a maximum distance in the vertical direction of the battery (e.g., distance from the flat bottom surface to the flat top surface of the battery).

Referring to FIGS. 1 to 3, an ultra-small secondary battery 500 according to some embodiments of the present disclosure may include an electrode assembly 100, a housing can 200, and a cap assembly 400.

The electrode assembly 100 may include positive electrode plates 101 and negative electrode plates 102 provided on opposite sides of separators 103 formed of an insulating material. In this exemplary embodiment, the electrode assembly 100 is configured to have a jelly roll structure as a whole, in which the positive electrode plates 101, the separators 103, and the negative electrode plates 102 are stacked on one another and then wound around a winding shaft RS. The winding shaft RS may be disposed perpendicularly to a bottom of the housing can, and the positive and negative electrode plates may be disposed alternately from the winding axis toward the outer circumferential surface. Accordingly, the electrode assembly 100 may be provided in a cylindrical shape in which the positive electrode plates 101 and the negative electrode plates 102 are stacked on one another, with the separator 103 provided therebetween, and top and bottom surfaces of the cylindrical shape may be configured to be flat.

Selectively, in some embodiments, an insulating sheet 300 may be disposed on a top surface of the electrode assembly 100 to electrically separate the positive electrode plates 101 and the negative electrode plates 102 positioned thereunder from a positive electrode tab 110 and the cap assembly 400 positioned thereover. For example, the insulating sheet 300 may be formed of a resin composition.

The insulating sheet 300 is shown as being disposed on the top surface of the electrode assembly 100 in this exemplary embodiment, but it is apparent that the insulating sheet may also be disposed on the bottom surface of the electrode assembly 100 as desired.

In this case, the winding shaft RS may be disposed in the height direction of the housing can 200 to provide a height substantially equal to the height H of the housing can 200. Although not shown, the winding shaft RS may be implemented as a hollow cylinder to allow gas and electrolyte to flow therein. In another example, the winding shaft RS may be implemented as a solid cylinder (not shown).

The respective electrode plates including the positive electrode plates 101 and the negative electrode plates 102 may be provided in the form of a strap with an active material applied thereto, and may be joined to opposite sides of the separators 103.

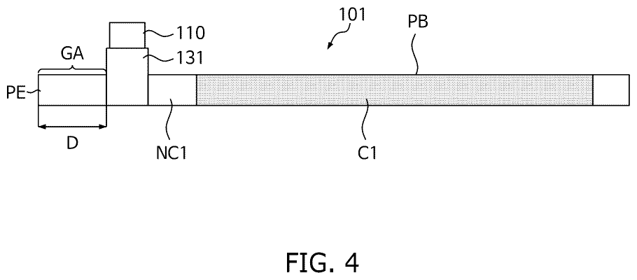

FIG. 4 illustrates a spread shape of the positive electrode plate shown in FIG. 3.

Referring to FIG. 4, the positive electrode plate 101 includes a single strap-shaped positive electrode substrate PB including a positive electrode coated portion C1 to which a positive electrode active material is applied and a positive electrode uncoated portion NC1 to which no positive electrode active material is applied. The positive electrode tab 110 is connected to the positive electrode uncoated portion NC1. For example, the positive electrode tab 110 may be a positive electrode substrate tab formed by stamping the positive electrode uncoated portions NC1.

In this embodiment, the positive electrode uncoated portion NC1 may be provided as positive electrode uncoated portions disposed on opposite ends of the positive electrode substrate PB, and the positive electrode coated portion C1 may be disposed between the pair of positive electrode uncoated portions NC1. In particular, the positive electrode tab 110 connected to one of the positive electrode uncoated portions NC1 may be disposed on one of the positive electrode uncoated portions NC1 so as to be spaced apart from a positive electrode edge PE, which is a first end of the positive electrode substrate PB, by a predetermined spacing distance D.

The positive electrode tab 110 is positioned on the positive electrode uncoated portion NC1 so as to be spaced apart from the positive electrode edge PE of the positive electrode substrate PB by a spacing area GA, which is an area of the positive electrode substrate PB corresponding to the spacing distance D.

The positive electrode edge PE may be provided as an outer circumferential surface on the cylindrical electrode assembly PA formed after winding of the positive electrode substrate PB. Accordingly, the positive electrode tab 110 may be disposed on an intermediate portion of the electrode assembly 100 so as to be spaced apart from the sidewall 202 of the housing can 200.

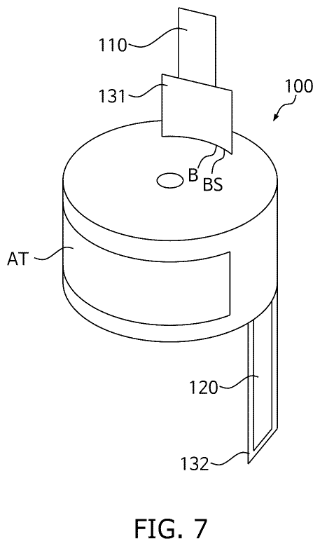

For example, the positive electrode tab 110 may include: a first vertical extension 111 disposed between the outer circumferential surface of the electrode assembly 100 and the winding shaft RS, connected to the positive electrode uncoated portion NC1, and extending in the height direction of the electrode assembly 100 (from the positive electrode uncoated portion); a first horizontal joint 112 extending from the first vertical extension 111 in a horizontal direction along the top surface of the electrode assembly 100, with a distal end joined to the cap assembly 400; and a first bend 113 bent at the boundary (e.g., boundary B shown in FIG. 7) between an upper portion and a side portion of the electrode assembly 100 to connect the first vertical extension 111 and the first horizontal joint 112 to each other.

In this exemplary embodiment, the positive electrode tab 110 may have a single square shape and may be bent at the boundary B of the electrode assembly 100 to extend to the upper portion of the winding shaft RS. The positive electrode tab 110 may be configured to be joined to a positive electrode terminal 440 of the cap assembly 400 positioned above the winding shaft RS.

In this exemplary embodiment, a first cover tape 131 may be disposed on the first vertical extension 111, the first bend 113, and the first horizontal joint 112 adjacent to the first bend 113 to strengthen the bond between the positive electrode tab 110 and the electrode assembly 100. The positive electrode tab may thus be fixed to the electrode assembly.

The first cover tape 131 may be provided to have a greater width than the positive electrode tab 110 so as to adhere to the positive electrode tab 110 at a central portion thereof and to the electrode assembly 100 at both peripheral portions of the positive electrode tab 110. Accordingly, the positive electrode tab 110 may be firmly bonded to the electrode assembly 100. In this embodiment, the first cover tape 131 has a larger width than the positive electrode tab 110, and thus the spacing distance D is defined as the distance between the positive electrode edge PE and the first cover tape 131, and may range from about 3 mm to about 10 mm. The spacing distance may therefore be a value ranging from 3 mm to 10 mm. In a case where the spacing distance D is less than 3 mm, it can be difficult to avoid damage to the positive electrode tab 110 during welding. In a case where the spacing distance D is larger than 10 mm, it can be difficult to maintain the placement balance with a negative electrode tab 120 positioned thereunder due to excessive proximity to the winding shaft RS. Accordingly, the spacing distance D may have a range of 3 mm to 10 mm, and desirably, may be set to have a range of about 3 mm to about 6 mm.

In this exemplary embodiment, the positive electrode tab 110 and the first cover tape 131 covering the positive electrode tab 110 may be placed a certain distance away from the sidewall of the housing can 200, which can be a weld area, or placed in an area where welding heat is not radiated, to prevent a short-circuit defect.

For example, the positive electrode substrate PB may be implemented as a current collector containing aluminum (AI). The positive electrode active material may be applied to the positive electrode substrate PB in the form of a mixture mixed with a binder and/or a coating material to form a positive electrode active material layer.

An amount of the positive electrode active material may be about 90 wt % to about 99.5 wt % based on 100 wt % of the positive electrode active material layer. Amounts of the binder and the conductive material may be about 0.5 wt % to about 5 wt %, respectively, based on 100 wt % of the positive electrode active material layer.

The binder serves to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be used to impart conductivity (e.g., electrical conductivity) to the electrode. Any material that does not cause chemical change (e.g., does not cause an undesirable chemical change in the rechargeable lithium battery) and conducts electrons can be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

In this exemplary embodiment, the positive electrode substrate PB is formed of a metal foil, such as aluminum (Al) foil, and the positive electrode active material coated on the positive electrode substrate PB may contain manganese dioxide. However, this configuration is illustrative, and various positive electrode substrates and positive electrode active materials may be used depending on the characteristics of the ultra-small secondary battery 500.

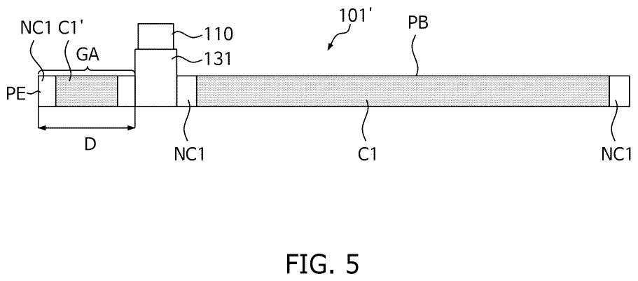

FIG. 5 illustrates a modified embodiment of the positive electrode shown in FIG. 4.

Referring to FIG. 5, the modified positive electrode plate 101′ according to other embodiments of the present disclosure may further include an additional positive electrode coated portion C1′ in the spacing area GA between the positive electrode edge PE and the first cover tape 131.

For example, the additional positive electrode coated portion C1′ may be an area coated with the same active material as the positive electrode coated portion C1, and may expand the active material coated area of the positive electrode substrate PB. Accordingly, compared to the positive electrode plate 101, the modified positive electrode plate 101′ may increase the capacity of the secondary battery 500.

In this depicted embodiment, the additional positive electrode coated portion C1′ may be disposed to cover from about ½ to about ⅔ of the spacing area GA. In particular, a portion of the positive electrode substrate PB adjacent to the positive electrode edge PE may be implemented as a positive electrode uncoated portion NC1 so as to overlap a positive electrode uncoated portion NC1 provided on a second end of the positive electrode substrate PB corresponding to the positive electrode edge PE. Accordingly, the additional positive electrode coated portion C1′ may be disposed between the positive electrode uncoated portion NC1 adjacent to the positive electrode edge PE and the first cover tape 131.

In addition, a positive electrode uncoated portion NC1 may also be selectively disposed between the first cover tape 131 and the additional positive electrode coated portion C1′. For example, in a case where the positive electrode tab 110 is positioned on an intermediate portion of the first cover tape 131, the additional positive electrode coated portion C1′ may be positioned adjacent to the boundary of the first cover tape 131.

Because the positive electrode uncoated portion NC1 is positioned in an area covered with the first cover tape 131, the positive electrode tab 110 may be electrically separated from the additional positive electrode coated portion C1′ even in the case that the additional positive electrode coated portion C1′ is adjacent to the first cover tape 131.

In contrast, in a case where the positive electrode tab 110 is positioned in a boundary area of the first cover tape 131, the additional positive electrode coated portion C1′ may be positioned to be spaced apart from the first cover tape 131. Accordingly, the additional positive electrode uncoated portion NC1 may be further disposed between the additional positive electrode coated portion C1′ and the first cover tape 131.

According to the modified positive electrode plate 101′ described above, the concentration loss of the positive electrode active material may be minimized even in the case that the positive electrode tab 110 is disposed in an intermediate portion of the positive electrode substrate PB rather than on one end. Accordingly, the capacity degradation of the secondary battery 500 due to the repositioning of the positive electrode tab 110 may be prevented.

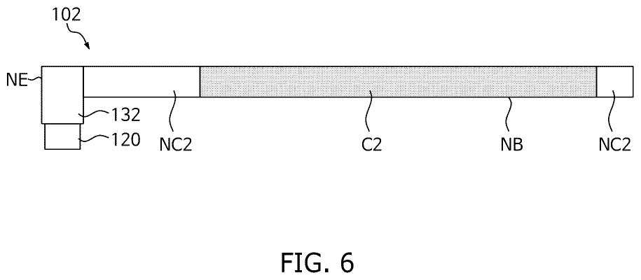

FIG. 6 illustrates a spread shape of the negative electrode plate shown in FIG. 3.

Referring to FIG. 6, the negative electrode plate 102 includes a strap-shaped negative electrode substrate NB including a negative electrode coated portion C2 with a negative electrode active material applied thereto and negative electrode uncoated portions NC2 with no negative electrode active material applied thereto, and the negative electrode tab 120 is connected to one of the negative electrode uncoated portions NC2. For example, the negative electrode tab 120 may be a negative electrode substrate tab formed by stamping the negative electrode uncoated portion NC2.

In this depicted embodiment, the negative electrode uncoated portions NC2 may be disposed on opposite ends of the negative electrode substrate NB, and the negative electrode coated portion C2 may be disposed between the pair of negative electrode uncoated portions NC2. In particular, the negative electrode tab 120 disposed on the negative electrode uncoated portion NC2 may be disposed on the negative electrode edge NE, which is one end of the negative electrode substrate NB, unlike the positive electrode tab 110. Accordingly, the negative electrode tab 120 may be disposed on the cylindrical outer circumferential surface of the jelly roll after winding.

The positive electrode tab 110 extending above the electrode assembly 100 may be damaged by welding heat between the top portion of the housing can 200 and the cap assembly 100, but the negative electrode tab 120 extending below the electrode assembly 100 and connected to a bottom 201 of the housing can 200 may not be affected by the welding. Accordingly, the negative electrode tab 120 may be disposed on the negative electrode edge NE and thus may be positioned adjacent to the sidewall 202 of the housing can.

The negative electrode tab 120 may include a second vertical extension 121 disposed on the outer circumferential surface of the electrode assembly 100 to be connected to the negative electrode uncoated portion (NC2) and extending in the height direction of the electrode assembly 100, a second horizontal joint 122 extending from the second vertical extension 121 in a horizontal direction along the back surface of the electrode assembly 100 to be joined to the bottom 201 of the housing can 200, and a second bend 123 connecting the second vertical extension 121 and the second horizontal junction/joint 122 to each other and bent on the outer circumferential surface of the electrode assembly 100.

In this depicted embodiment, the negative electrode tab 120 has a single square shape, and may be bent at the boundary of the outer circumferential surface and the back surface of the electrode assembly 100 and extend to cover the lower portion of the winding shaft RS.

In this case, a second cover tape 132 may be disposed on the second vertical extension 121, the second bend 123, and the second horizontal joint 122 adjacent to the second bend 123 to strengthen the bond between the negative electrode tab 120 and the electrode assembly 100.

In particular, in this exemplary embodiment, the second vertical extension 121 is configured such that the entirety thereof is covered with the second cover tape 132, but the second horizontal joint 122 is configured such that only a portion thereof is covered with the second cover tape 132. Accordingly, a sufficient joint area may be obtained between the second horizontal joint 122 and the floor or bottom 201.

For example, the second horizontal joint 122 adjacent to the second bend 123 is configured to be covered with the second cover tape 132, but the second horizontal joint 122 adjacent to the winding shaft RS is configured to be directly joined to the bottom 201 without the second cover tape 132.

Accordingly, the second horizontal joint 122 adjacent to the winding shaft RS may have a greater thickness than the second horizontal joint 122 adjacent to the second bend 123, and may be directly joined to the bottom 201 of the housing can 200.

For example, the negative electrode substrate NB may be implemented as a current collector, and the negative electrode active material may be applied to the negative electrode substrate NB in the form of a mixture with a binder and/or a conductive material to form a negative electrode active material layer.

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles well to each other and also to attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, or a combination thereof.

The conductive material may be used to impart conductivity (e.g., electrical conductivity) to the electrode. Any material that does not cause chemical change (e.g., does not cause an undesirable chemical change in the rechargeable lithium battery) and that conducts electrons can be used in the battery. Non-limiting examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

The negative current collector may include a copper foil, a nickel foil, a stainless steel foil, a titanium foil, a nickel foam, a copper foam, a polymer substrate coated with a conductive metal, or a combination thereof.

In this depicted embodiment, the negative electrode substrate NB may be implemented as a metal foil, such as a copper (Cu) foil, and the negative electrode active material coated on the substrate may contain lithium (Li). Accordingly, the ultra-small secondary battery 500 may be implemented as a manganese dioxide lithium battery including manganese dioxide as the positive electrode active material and lithium as the negative electrode active material.

However, this exemplary embodiment is illustrative, and various negative electrode substrates and negative electrode active materials may be used depending on the characteristics of the ultra-small secondary battery 500.

FIG. 7 illustrates a perspective view schematically showing the electrode assembly shown in FIG. 2.

Referring to FIG. 7, the electrode assembly 100 is provided as a cylindrical jelly roll battery manufactured by winding the positive electrode plates 101 and the negative electrode plates 102 symmetrically disposed with respect to the separators 103, followed by finishing with an adhesive tape AT.

In this case, the positive electrode tab 110 may be bent to face upward at the boundary B at a position spaced apart from the outer circumferential surface of the electrode assembly 100 toward the winding shaft RS (e.g., toward an inside of the cylindrical shape of the electrode assembly) and is connected to the cap assembly 400 described later, and the negative electrode tab 120 may be bent from the outer circumferential surface of the electrode assembly 100 toward the back surface BS and is connected to the housing can 200, as described later.

Accordingly, in the ultra-small secondary battery 500, the cap assembly 400 functions as a positive electrode terminal and the housing can 200 functions as a negative electrode terminal. In this exemplary embodiment, in a case where the top surface of the electrode assembly 100 is covered with the insulating sheet 300, the positive electrode tab 110 may be disposed on the insulating sheet 300.

Referring to FIGS. 1 to 3, the electrode assembly 100 described above is received in the housing can 200 to form a housing structure HS.

The housing can 200 has a cylinder shape including the bottom 201 and the sidewall 202 extending from the periphery of the bottom 201, in which a housing space defined by the bottom 210 and the sidewall 202 is exposed through an open area O provided on one side. Accordingly, the housing can 200 is provided as an open cylinder structure.

In particular, the housing can 200 may be provided in a cylindrical shape with a diameter d sufficiently larger than the height H so that the ultra-small secondary battery 500 may be configured as a button or coin type battery. In this embodiment, the ratio of the height H to the diameter d of the housing can 200 may be set to be less than 1, so that the size of the secondary battery 500 may be minimized due to a button or coin shape.

The negative electrode tab 120 may be bent at the boundary between the sidewall and the back surface BS of the electrode assembly 100, bonded to the back surface with the second cover tape 132, and inserted into the housing can 200 so as to be provided to the housing structure HS.

Because the negative electrode tab 120 can be bonded to the back surface of the electrode assembly 100 with the second cover tape 132, the negative electrode tab 120 is bonded to the bottom 201 of the housing can 200 in the housing structure HS. At this time, the outermost circumferential surface of the electrode assembly 100 and the sidewall 202 of the housing can 200 are in close proximity to each other.

For example, the housing can 200 can be formed of corrosion-resistant steel (e.g., steel use stainless; SUS) and can be connected to the negative electrode tab 120 via the bottom 201 to function as the negative electrode of the secondary cell 500.

In some embodiments, the cap assembly 400 may cover the open area O to be joined to the positive electrode tab 110, thereby sealing the electrode assembly 100 from the outside (e.g., an outside region).

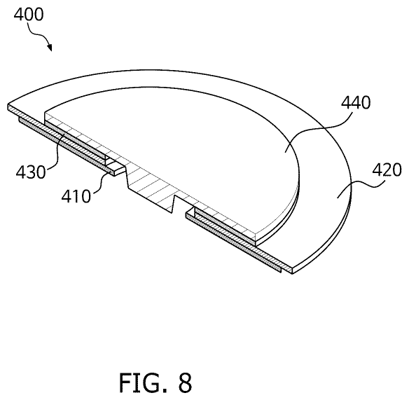

FIG. 8 illustrates a perspective view schematically showing the cap assembly shown in FIG. 3.

Referring to FIG. 8, the cap assembly 400 according to embodiments of the present disclosure may include an insulating washer 410, a cap plate 420, a terminal insulating layer 430, and a positive electrode terminal 440 stacked on one another.

The cap assembly 400 may be aligned along a joining step surface SS of the housing can 200 and then joined thereto by welding to seal the electrode assembly 100 positioned therein from the outside. Accordingly, a weld line WL joining the housing can 200 and the cap assembly 400 may be formed along the joining step surface SS.

The insulating washer 410 may be disk-shaped with a first opening, open area O1 in the central portion to expose the winding shaft RS and configured to cover the positive electrode tab 110.

The positive electrode tab 110 may be bent at the boundary B to extend along the top surface of the electrode assembly 100, with an end positioned above the winding shaft RS. In this case, the insulating washer 410, having the disk shape with the first opening, open area O1 exposing the end of the positive electrode tab 110 positioned above the winding shaft RS, is provided on the lowermost portion of the cap assembly 400.

Accordingly, the insulating washer 410 is disposed to cover the first horizontal joint 112 adjacent to the first bend 113. The first horizontal joint 112 may be configured such that the end thereof is exposed through the first open area O1 and the remaining area is covered with the insulating washer 410 so as to be electrically insulated from the cap plate 420 positioned thereover.

In this case, the outer end/edge of the insulating washer 410 may be disposed closer to the housing can 200 than the first bend 113 so as to be positioned between the sidewall 202 of the housing can 200 and the first bend 113.

The outer edge of the insulating washer 410 may be disposed closer to the sidewall 202 of the housing can 200 to protect the positive electrode tab 110 positioned thereunder from welding heat. Accordingly, during welding of the housing can 200 and the cap assembly 400, the first cover tape 131 may be prevented from being melted by welding heat and exposing the positive electrode tab 110.

The cap plate 420 is disposed on the top surface of the insulating washer 410, and may have a second open area O2 having the same center as the first open area O1, with the edge thereof joined to the housing can 200. Accordingly, the cap plate 420 may be provided in the shape of a disk having the second open area O2 in the central portion to expose the end of the first horizontal joint 112 and the outer edge corresponding to the shape of the housing can 200.

However, it will be appreciated that the disk shape is illustrative and that the cap plate 420 may have a variety of shapes depending on the shape of the top portion of the housing can 200.

In this depicted embodiment, a portion of the top portion of the housing can 200 may be removed to provide the joining step surface SS. For example, the top surface of the housing can 200 may be removed in an “L” shape to provide the joining step surface SS having a flat surface, and the outer edge of the cap plate 420 may be inserted into and aligned with the joining step surface SS.

Accordingly, in a case where the cap assembly 400 is disposed above the housing can 200, alignment may be automatically performed by the joining step surface SS and the outer edge of the cap plate 420. After the alignment is completed, the cap plate 420 and the housing can 200 may be joined along the joining step surface SS. For example, the cap plate 420 and the housing can 200 may be joined by laser welding.

In this case, the first bend 113 of the positive electrode tab 110 and the first cover tape 131 surrounding the first bend 113 are disposed at a sufficient distance by the joining step surface to prevent melting caused by welding heat.

For example, the first bend 113 and the first cover tape 131 covering the first bend 113 may be set (positioned) to be in an area where radiant heat from the welding of the joining step surface SS and the cap plate 420 is less than 50% of welding heat, thereby reducing the melting of the first cover tape 131 caused by the welding.

Because the welding process for joining the housing can 200 and the cap plate 420 is performed along the joining step surface SS, the joining step surface SS may function as a heat source for the welding heat during the welding process. Accordingly, the first bend 113 may be set to be sufficiently spaced apart from the joining step surface SS or the sidewall 202 to prevent radiant heat from the weld heat from reaching the first bend 113.

For example, the first bend 113 may be positioned to be spaced apart from the sidewall 202 of the housing can 200 by a predetermined distance, in a position below the joining step surface SS. For example, the first bend 113 may be positioned to be spaced apart from the sidewall 202 (of the housing can on a bottom of the joining step surface) in a range of about 4 mm to 11 mm. However, this is illustrative, and the first bend 113 may be positioned variously depending on the properties and welding characteristics of the housing can 200 and the cap plate 420, as long as the radiation of welding heat may be sufficiently blocked.

During the welding process, the boundary B of the electrode assembly 100 where the first bend 113 is positioned may reduce the width of the first bend 113 to prevent poor welding caused by the first cover tape 131.

Because the electrode assembly 100 may be provided in a cylindrical shape and each of the positive electrode tab 110 and the first cover tape 131 is provided in a square shape, the interference between the arc and the straight line may occur at the boundary B. In particular, because the first cover tape 131 is set to have a greater width than the positive electrode tab 110, the first cover tape 131 may extend across the electrode assembly 100 at the boundary B and to the weld area of the housing can 200 and the cap plate 420, thereby partially causing a weld defect.

Accordingly, modifying the positive electrode tab 110 to reduce the width of the first bend 113 may also reduce the width of the first cover tape 131 covering the first bend 113, thereby minimizing the weld defect caused by the interference between the first cover tape 131 and the weld area.

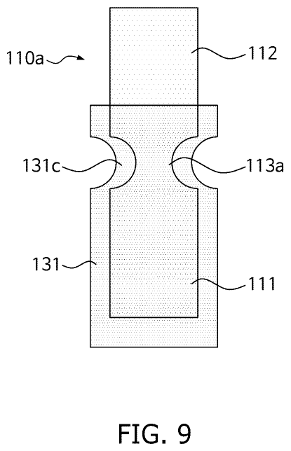

FIG. 9 illustrates a modified positive electrode tab according to embodiments of the present disclosure.

As shown in FIG. 9, a modified positive electrode tab 110a has the same first vertical extension 111 and first horizontal joint 112 as the positive electrode tab 110, and has a modified first bend 113a modified into a recessed shape to reduce the width. According to the recessed shape of the modified first bend 113a, the shape of the first cover tape 131 covering the modified first bend 113a is also reduced in width at the recessed portion 131c. The first bend may be configured to have a width smaller than either the first vertical extension or the first horizontal joint, such that an area of the first cover tape corresponding to the first bend has a width smaller than an area corresponding to either the first vertical extension or the first horizontal joint.

Accordingly, the interference of the first cover tape 131 with the weld area of the housing can 200 and the cap plate 420 at the boundary B of the electrode assembly 100 may be prevented or reduced.

Because the second cover tape 132 adhering to the negative electrode tab 120 is in contact with the bottom 201 of the housing can 200 on the back surface BS of the electrode assembly 100, a defect in which the second cover tape 132 is removed by welding does not occur. Accordingly, the second cover tape 132 may be relatively free from the melting defect caused by welding heat.

In response to the welding of the housing can 200 and the cap plate 420, the internal space of the housing can 200 is sealed from the outside. Accordingly, the electrode assembly 100 received in the housing can 200 is sealed from the outside.

The joined cap plate 420 and housing can 200 may function as an electrically unitary member to function as the negative electrode of the ultra-small secondary battery 500. Accordingly, the cap plate 420 may be formed of the same material as the housing can 200. For example, like the housing can 200, the cap plate 420 may be formed of SUS.

The terminal insulating layer 430 may be disposed on the cap plate 420 to have a third open area O3 having the same center as the first open area O1 and the second open area O2 so as to separate the positive electrode terminal 440 positioned thereover and the cap plate 420.

The terminal insulating layer 430 may be implemented as an insulating sheet or an insulating member having a size corresponding to the size of a terminal plate 441 disposed thereover. Accordingly, the positive electrode terminal 440 having the positive electrode and the cap plate 420 having the negative electrode may be electrically insulated by the terminal insulating layer 430.

The positive electrode terminal 440 may include the terminal plate 441 and a joining protrusion 442. The terminal plate 441 can seal the electrode assembly 100 by covering the terminal insulating layer 430. The joining protrusion 442 extends downward from the terminal plate 441 and through the first to the third open areas O1 to O3 to be joined to the positive electrode tab 110.

The positive electrode terminal 440 may form the outermost portion of the cap assembly 400 and electrically connect the ultra-small secondary battery 500 to an external system. The terminal plate 441 is provided as a flat plate that sufficiently covers the terminal insulating layer 430 and the open first to third open areas O1 to O3 and is sufficiently resistant to external force, and the joining protrusion 442 protrudes from the back surface of the terminal plate 441 and is inserted into the first to third open areas O1 to O3. Accordingly, the bonding/joining protrusion 442 is connected to the terminal plate 441 and extends through the first to third open areas O1 to O3 to be connected to the positive electrode tab 110.

According to the ultra-small secondary battery described above, disposing the positive electrode tab 110 within the jelly roll by moving the position of the positive electrode tab 110 from the outer surface of the electrode assembly 100 toward the winding axis may prevent the first cover tape from dissolving and the positive electrode tab 110 from being exposed during welding of the housing can 200 and the cap plate 420.

Accordingly, short-circuit defects in which the cap plate 420 and the positive electrode tab 110 are in contact may be prevented. In particular, even in a case where the size of the housing can 200 is reduced, a situation in which the first cover tape dissolves due to welding or the positive electrode tab 110 and the cap plate 420 contact each other may be effectively prevented, thereby increasing the operational stability of the ultra-small secondary battery.

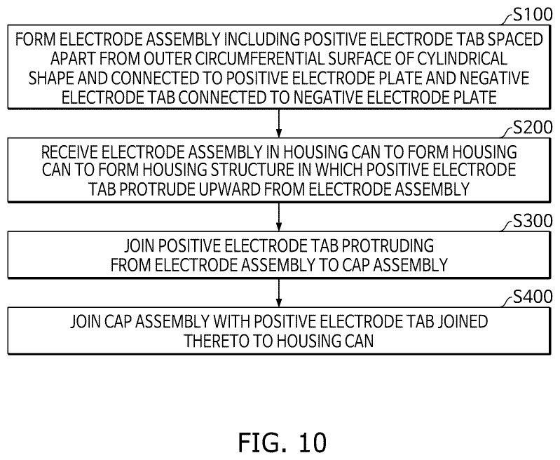

FIG. 10 illustrates a flowchart showing a method of manufacturing the ultra-small secondary battery shown in FIG. 1.

Referring to FIG. 10, first, an electrode assembly 100 having a cylindrical shape and having a positive electrode tab 110 spaced apart from the outer circumferential surface of the cylindrical shape to the inner surface of the cylindrical shape is formed (at step S100).

For example, a positive electrode plate 101 coated with a positive electrode active material and a negative electrode plate 102 coated with a negative electrode active material may be individually formed and then pressed onto a separator 103 by a laminating process.

After the positive electrode tab 110 connected to the positive electrode plate 101 and the negative electrode tab 120 connected to the negative electrode plate are formed, the electrode assembly 100 may be formed in a jelly roll structure.

In some embodiments, during manufacture of the positive electrode plate 101, the positive electrode tab 110 may be formed at a position where the radiation of the welding heat may be blocked. For example, the positive electrode tab 110 may be formed at a position spaced apart from the end of the positive electrode plate 101 by 0.5 mm to 3.0 mm, and the negative electrode tab 120 may be formed on an end of the negative electrode plate 102.

Thereafter, the electrode assembly 100 may be received in the housing can 200 and/or inserted into the housing can such that the negative electrode tab 120 is electrically connected to the housing can 200 to form a housing structure HS in which the positive electrode tab 110 protrudes upward from the electrode assembly 100 (at step S200).

For example, the negative electrode tab 120 may be bent and bonded to the back surface of the electrode assembly 100 and then inserted into the housing can 200 so that the negative electrode tab 120 contacts the bottom 201 of the housing can 200. The insertion of the electrode assembly 100 into the housing can 200 may be performed by a transfer robot.

Subsequently, the positive electrode tab 110 protruding from the electrode assembly 100 and a cap assembly 400 may be joined (at step S300).

First, the housing structure HS may be fixed to an alignment substrate, such as a jig, using a transfer means, and then a cap fixing terminal to which the cap assembly 400 is fixed is aligned with the positive electrode tab 110. For example, a joining protrusion 442 of a positive electrode terminal 440 and an end of a first horizontal joint 112 may be aligned with each other.

Thereafter, the positive electrode terminal 440 provided on the cap assembly 400 and the positive electrode tab may be joined by laser welding.

Subsequently, the cap assembly 400 with the positive electrode tab 110 joined thereto and the housing can 200 may be joined (at step S400) to complete an ultra-small secondary battery 500.

The cap assembly 400 joined to the positive electrode tab 110 may be pressed to be aligned with the top portion of the housing can 200, and the cap assembly 400 may be joined along the periphery (peripheral portions) of the housing can 200 by laser welding.

In some embodiments, the cap assembly 400 may be pressed by an alignment roller (not shown) to press the top front surface (e.g., entire top front surface) of the cap assembly 400 against the housing can 200 so that the edge of the cap plate 420 provided on the cap assembly 400 may be fitted to the joining step surface SS provided on an end of the housing can 200.

According to the above-described ultra-small secondary battery and the method of manufacturing the same, disposing the positive electrode tab 110 within the jelly roll by moving the position of the positive electrode tab 110 from the outer surface of the electrode assembly 100 toward the winding shaft may prevent the first cover tape from dissolving and the positive electrode tab 110 from being exposed during welding of the housing can 200 and the cap plate 420.

Accordingly, short-circuit defects in which the cap plate 420 and the positive electrode tab 110 are in contact may be prevented. In particular, even in a case where the size of the housing can 200 is reduced, a situation in which the first cover tape dissolves due to welding or the positive electrode tab 110 and the cap plate 420 contact each other may be effectively prevented, thereby increasing the operational stability of the ultra-small secondary battery.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

What is claimed is:

1. A secondary battery comprising:
an electrode assembly comprising a positive electrode plate and a negative electrode plate separated by a separator and wound in a cylindrical shape, a positive electrode tab spaced apart from an outer circumferential surface of the cylindrical shape toward an inside of the cylindrical shape and connected to the positive electrode plate, and a negative electrode tab connected to the negative electrode plate;
a housing can configured to receive the electrode assembly, the housing can electrically connected to the negative electrode tab and having an open area at one side; and
a cap assembly electrically connected to the positive electrode tab and configured to close the open area to seal the electrode assembly from an outside region.

2. The secondary battery as claimed in claim 1, wherein the positive electrode plate comprises a strap-shaped positive electrode substrate comprising a positive electrode coated portion to which a positive electrode active material is applied and a positive electrode uncoated portion to which the positive electrode active material is not applied, and
wherein the positive electrode tab is positioned on the positive electrode uncoated portion so as to be spaced apart from a positive electrode edge, which is an end of the positive electrode substrate, by a spacing area corresponding to a spacing distance.

3. The secondary battery as claimed in claim 2, wherein the positive electrode edge is provided as the outer circumferential surface after being wound in the cylindrical shape, and the spacing distance ranges from 3 mm to 10 mm.

4. The secondary battery as claimed in claim 2, wherein the positive electrode plate further comprises an additional positive electrode coated portion in which a portion of the positive electrode substrate corresponding to the spacing area is coated with the positive electrode active material.

5. The secondary battery as claimed in claim 2, wherein the positive electrode tab comprises:
a first vertical extension configured to extend from the positive electrode uncoated portion in a height direction of the electrode assembly;
a first horizontal joint configured to extend horizontally along a top surface of the electrode assembly; and
a first bend configured to connect the first vertical extension and the first horizontal joint.

6. The secondary battery as claimed in claim 5, wherein the positive electrode tab further comprises a first cover tape covering a portion of the first vertical extension, the first bend, and the first horizontal joint to be fixed to the electrode assembly.

7. The secondary battery as claimed in claim 6, wherein the first bend is configured to have a width smaller than either the first vertical extension or the first horizontal joint, such that an area of the first cover tape corresponding to the first bend has a width smaller than an area corresponding to either the first vertical extension or the first horizontal joint.

8. The secondary battery as claimed in claim 6, wherein the cap assembly comprises:
a disk-shaped insulating washer configured to have a first open area in a central portion to expose a winding shaft and configured to cover the positive electrode tab;
a cap plate disposed on a top surface of the disk-shaped insulating washer and having a second open area having a same center as the first open area, with an edge thereof joined to the housing can;
a terminal insulating layer disposed on the cap plate and having a third open area having the same center as the first open area and the second open area; and
a positive electrode terminal comprising a terminal plate configured to seal the electrode assembly by covering the terminal insulating layer and a joining protrusion extending downward from the terminal plate and through the first to the third open areas to be joined to the positive electrode tab.

9. The secondary battery as claimed in claim 8, wherein a top portion of the housing can comprises a joining step surface, and wherein the edge of the cap plate is welded to the joining step surface.

10. The secondary battery as claimed in claim 9, wherein the first bend is positioned in an area where radiant heat from welding of the joining step surface and the cap plate is less than 50% of welding heat, thereby preventing or reducing melting of the first cover tape by the welding.

11. The secondary battery as claimed in claim 9, wherein the first bend has a spacing ranging from 4 mm to 11 mm from a sidewall of the housing can on a bottom of the joining step surface.

12. The secondary battery as claimed in claim 8, wherein an outer edge of the insulating washer is disposed closer to the housing can than the first bend so as to be positioned between a sidewall of the housing can and the first bend.

13. The secondary battery as claimed in claim 1, wherein a height to diameter ratio of the housing can is less than 1.

14. The secondary battery as claimed in claim 1, wherein the positive electrode plates, the separators, and the negative electrode plates are wound around a winding axis disposed perpendicularly to a bottom of the housing can, and wherein the positive electrode plates and the negative electrode plates are disposed alternately from the winding axis toward the outer circumferential surface.

15. A method of manufacturing a secondary battery, the method comprising:
forming an electrode assembly comprising a positive electrode plate and a negative electrode plate separated by a separator and wound in a cylindrical shape, a positive electrode tab spaced apart from an outer circumferential surface of the cylindrical shape toward an inside of the cylindrical shape and connected to the positive electrode plate, and a negative electrode tab connected to the negative electrode plate;
inserting the electrode assembly in a housing can such that the negative electrode tab is electrically connected thereto to form a housing structure in which the positive electrode tab protrudes upward from the electrode assembly;
joining the positive electrode tab protruding from the electrode assembly to a cap assembly; and
joining the cap assembly with the positive electrode tab joined thereto to the housing can.

16. The method as claimed in claim 15, wherein the positive electrode tab is formed at a position spaced apart from an end of the positive electrode plate by a distance ranging from 3 mm to 10 mm, and wherein the negative electrode tab is formed on an end of the negative electrode plate.

17. The method as claimed in claim 15, wherein the operation of joining the positive electrode tab to the cap assembly comprises:
fixing the housing structure to an alignment substrate;
aligning a cap fixing terminal to which the cap assembly is fixed with the positive electrode tab; and
joining a positive electrode terminal provided on the cap assembly to the positive electrode tab.

18. The method as claimed in claim 17, wherein the joining of the positive electrode terminal and the positive electrode tab is performed by laser welding.

19. The method as claimed in claim 15, wherein the joining of the cap assembly and the housing can comprises:
pressing the cap assembly joined to the positive electrode tab to be aligned with a top portion of the housing can; and
laser-welding the cap assembly along peripheral portions of the housing can.

20. The method as claimed in claim 19, wherein in the aligning of the cap assembly to the top portion of the housing can, an entire top surface of the cap assembly is pressed against the housing can using an alignment roller to fit an edge of a cap plate provided on the cap assembly to a joining step surface provided on an end of the housing can.
